(19) United States
(12) Patent Application Publication
(10) Pub. No.: US 2005/0281632 A1
(43) Pub. Date: Dec. 22, 2005

(54) Punched/stamped rivet

(75) Inventor: Georg Donhauser, Amberg (DE)

Correspondence Address: FLEIT KAIN GIBBONS GUTMAN BONGINI & BIANCO, 21355 EAST DIXIE HIGHWAY, SUITE 115, MIAMI, FL, 33180, US

(73) Assignee: KERB-KONUS-VERTRIEBS-GMBH, AMBERG (DE)

(21) Appl. No.: 11/170,766

(22) Filed: Jun. 29, 2005

(30) Foreign Application Priority Data
Jan. 14, 2003 (DE) 103 01 114.5
Dec. 5, 2003 (WO) PCT/EP03/13756

(51) Int. Cl. F16B 13/04

(52) U.S. Cl. 411/29

(57) ABSTRACT

The invention relates to a punched/stamped rivet including a rivet head and a shank connected to the head, for punching through at least two parts to be joined lying one on top of the other. The shank contains at least one shank groove that can be filled with the material of at least the lower part to be joined, viewed in the punching direction, during a subsequent stamping operation. To prevent corrosion between the punched/stamped rivet and the parts to be joined, the punched/stamped rivet consists of a ceramic.

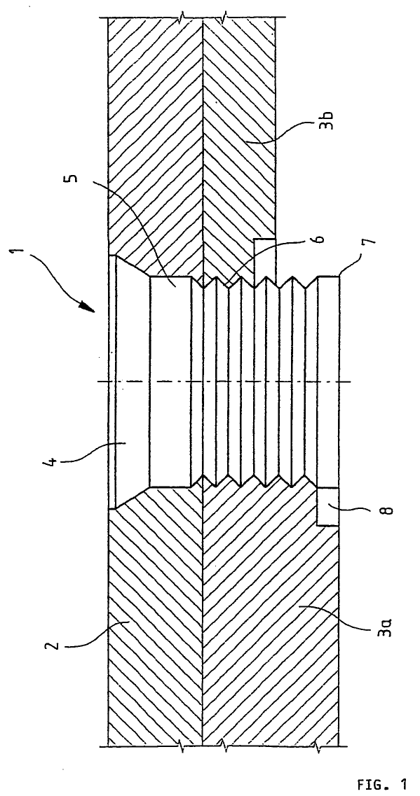

### CROSS-REFERENCE TO RELATED APPLICATION

This application is a continuation of International Application No. PCT/EP2003/013756 filed Dec. 5, 2003, the contents of which are incorporated herein by reference.

### FIELD OF THE INVENTION

The invention pertains to a punched/stamped rivet.

### BACKGROUND OF THE INVENTION

Such punched/stamped rivets are used for connecting two or more parts, two or more types of semi finished products, sheets, profiles and similar elements to be joined. In this case, the rivet is initially pressed through the two parts to be joined without pre punching by means of a riveting die, wherein the rivet simultaneously functions as a punch. After the stopping point of the riveting die is reached, the parts to be joined are pressed against a lower die with the now closed surface of riveting die and pressure pad. This causes an annular groove to be punched into the lower part to be joined around the shank end of the rivet such that the material of the lower part to be joined is pressed into at least one peripheral shank groove of the rivet.

Conventional punched/stamped rivets used so far are manufactured of steel. However, problems with respect to the corrosion between the punched rivet and the parts to be joined arise when materials that tend to corrode in combination with steel connecting elements need to be joined. This is why the rivet is usually provided with a corrosion protection layer in such instances. However, this corrosion protection layer may be partially destroyed when the rivet is punched into the parts to be joined such that the desired corrosion protection can no longer be ensured. In addition, hardly any coating is suitable for use on magnesium. One also encounters problems in the subsequent mechanical processing of the rivet by means of grinding. Hereby, the corrosion protection layer of the rivet is also damaged such that the component may corrode.

### SUMMARY OF THE INVENTION

The invention is based on the objective of developing a punched/stamped rivet of the initially described type that eliminates the aforementioned problems.

This objective is attained with a punched/stamped rivet with the characteristics set forth in the claims. Advantageous embodiments and practical additional developments of the invention are also disclosed in the claims.

The punched/stamped rivet according to the invention is manufactured of a compression proof ceramic material with high shear strength. The rivet geometry is realized, for example, by means of an injection molding process. The hardness of the rivet is achieved with a heat treatment after the molding process. Analogous to applications with a solid steel rivet; the ceramic rivet is pressed through the layers of parts to be joined without being destroyed.

An electrochemical potential is not created between the ceramic rivet and the material of the parts to be joined. This means that electrochemical corrosion is prevented due to the utilization of a non conductive ceramic material. The ceramic rivet can also be mechanically processed, for example, by means of a grinding machine.

The punched/stamped rivet preferably consists of oxide ceramics, non oxide ceramics or mixtures of various oxide ceramics or mixtures of various non oxide ceramics. It was determined that an aluminum oxide ceramic reinforced with zirconium oxide is particularly suitable in this respect, wherein the ceramic material has a zirconium content of more than 60 wt % and a material density in excess of 5.2 kg/dm³. The punched/stamped rivet advantageously has a compressive strength of more than 2900 N/mm², a flexural strength in excess of 700 N/mm², a fracture toughness of more than 8 K_{IC} and a modulus of elasticity of less than 270 N/mm². The hardness of the punched/stamped rivet should lie below 1900 HV 10 (Vickers hardness), and the ceramic material is also gas tight and acid resistant.

### BRIEF DESCRIPTION OF THE DRAWING

Other peculiarities and advantages of the invention are discussed in the following description of one embodiment that refers to the FIGURE. The FIGURE shows a so called multi range rivet for joining workpieces of different thicknesses.

### DETAILED DESCRIPTION OF THE INVENTION

The punched/stamped rivet 1 shown in the FIGURE is realized in the form of a so called multi range rivet that is suitable for respectively joining an upper part 2 and a thicker lower part 3a or a thinner lower part 3b. Such a punched/stamped rivet makes it possible to join parts of different thicknesses with only one type of rivet. The punched/stamped rivet 1 is realized in the form of a solid rivet and contains a rivet head 4 in the shape of a truncated cone, as well as an adjacent cylindrical shank 5 with several adjoining shank grooves 6 arranged therein. The lower end of the shank 5 is provided with a sharp edge 7 such that punched holes can be easily produced in the respective parts to be joined 2 and 3a or 3b.

In order to produce a rivet connection, this punched/stamped rivet 1 is pressed through the respective parts to be joined 2 and 3a or 3b that are fixed in position on a pressure pad from the top toward the bottom with the aid of a riveting die, not shown, namely such that aligned holes are punched into the respective parts to be joined. After the punching process is completed, an annular depression 8 is stamped into the respective lower part to be joined 3a or 3b around the shank 5 with the aid of a corresponding die. Due to this measure, the material of the lower part to be joined 3a or 3b is subjected to a plastic deformation such that it is pressed into and fills out the shank grooves 6.

The punched/stamped rivet 1 consists of an aluminum oxide ceramic that is reinforced with zirconium oxide, wherein this ceramic material has a zirconium oxide content of more than 60 wt % and a material density in excess of 5.2 kg/dm³.

The invention is not limited to the multi range rivet illustrated in the FIGURE and described in detail in the preceding paragraphs. The punched/stamped rivet may also contain only one shank groove. Instead of the notch configuration shown, the shank groove may also have a rounded or trapezoidal shape.

1. A punched/stamped rivet with a rivet head and an adjacent shank for punching through at least two parts to be joined that lie on top of one another, wherein the shank contains at least one shank groove that is filled with the material of at least the lower part to be joined, relative to the punching direction during a subsequent stamping process, characterized by the fact that the punched/stamped rivet consists of a ceramic material.

2. The punched/stamped rivet according to claim 1, characterized by the fact that the ceramic material consists of an aluminum oxide ceramic that is reinforced with zirconium oxide.

3. The punched/stamped rivet according to claim 1, characterized by the fact that the zirconium oxide reinforced aluminum oxide ceramic has a zirconium oxide content of more than 60 wt % and a material density in excess of 5.2 kg/dm³.

4. The punched/stamped rivet according to claim 1, characterized by the fact that the rivet has a compressive strength of more than 2900 N/mm².

5. The punched/stamped rivet according to claim 1, characterized by the fact that the rivet has a flexural strength in excess of 700 N/mm².

6. The punched/stamped rivet according to claim 1, characterized by the fact that the rivet has a fracture toughness of more than 8 K_{IC}.

7. The punched/stamped rivet according to claim 1, characterized by the fact that the rivet has a modulus of elasticity of less than 270 N/mm².

8. The punched/stamped rivet according to claim 1, characterized by the fact that the rivet has a hardness of less than 1900 HV 10.

9. The punched/stamped rivet according to claim 1, characterized by the fact that the ceramic material is gas tight and acid resistant.
